(19) United States
(12) Patent Application Publication
(10) Pub. No.: US 2010/0310932 A1
(43) Pub. Date: Dec. 9, 2010

(54) FLEXIBLE PACKAGING DEVICE OF A MICROBATTERY

(75) Inventors: Steve MARTIN, Saint-Sauveur (FR); Messaoud BEDJAOUI, Echirolles (FR); Sylvain POULET, Saint Victor de Cessieu (FR); Raphaël SALOT, Lans-en-Vercors (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE ET AUX ENERGIES ALTERNATIVES, Paris (FR)

(21) Appl. No.: 12/791,444

(22) Filed: Jun. 1, 2010

(30) Foreign Application Priority Data
Jun. 9, 2009 (FR) 09 02784

(51) Int. Cl. H01M 2/02; B32B 37/12

(52) U.S. Cl. 429/186; 156/278

(57) ABSTRACT

The packaging device of a microbattery arranged on a flexible support comprises at least one thin layer forming a protective barrier deposited on the whole of the microbattery, and a flexible compensation cover above the barrier. The cover is made from a material, for example polymer, with a thickness t_{comp} and a Young's modulus E_{comp} chosen such that the neutral plane of the assembly is situated at the level of the microbattery. The thickness of the cover is calculated, with an accuracy of ±30%, by the equation

$${t}_{comp} = \frac{{t}_{sub}}{\sqrt{η}}$$

in which t_{sub} is the thickness of the support and η the ratio of the Young's moduli of the cover and of the support.

### BACKGROUND OF THE INVENTION

The invention relates to a packaging device of a microbattery arranged on a surface of a flexible support having a Young's modulus E_{sub} and a thickness t_{sub}, the device comprising at least one thin layer forming a protective barrier and covering the microbattery fully and said surface of the flexible support at the periphery of the microbattery.

The invention also relates to a method for producing such a device.

### STATE OF THE ART

Lithium microbatteries are generally formed by two electrodes (positive and negative) separated by an electrolyte. Such a microbattery further comprises metal current collectors, made from platinum or tungsten for example. The positive electrode is made from a material having a good ionic conductivity, for example TiOS. The electrolyte is an electric insulator with a high ionic conductivity such as UPON. The negative electrode is made for example from metal lithium. As materials containing lithium are very sensitive to air, and particularly to oxygen, nitrogen and moisture, they have to be covered with an inert, gas-tight protective barrier. Mastering packaging is a prime factor that conditions the efficiency of microbatteries over time.

A first packaging solution consists in sticking a cover generally made from glass, with a thickness of about 1 mm, onto the component. This packaging device presents the advantage of considerably reducing diffusion of species into the component. The cover is however thick compared with the thickness of the battery and is not flexible. For numerous applications such as RFID (Radio Frequency IDentification) tags or sensors integrated in pneumatic tires, a high degree of flexibility of the microbattery/packaging device assembly has to be preserved.

The commonly used technical solution consists in depositing a packaging device comprising at least one thin layer forming a protective barrier on the microbattery. FIG. 1 represents a microbattery 2 covered by such a protective barrier 3, on a flexible support 1 formed by a substrate. The thickness of these packaging devices by thin-film deposition does not exceed 50 μM. Beyond this thickness, the deposition techniques used are in fact not suitable and the mechanical stresses internal to the packaging device lead to a loss of diffusion barrier effect.

Polymer materials have interesting mechanical properties for fabricating flexible packaging devices. However, they do not present sufficient properties to prevent diffusion of species that react with lithium. They are therefore always associated with at least one layer of dense material of ceramic or metallic type.

U.S. Pat. No. 5,561,004 describes a packaging device for thin-film lithium batteries. The packaging device comprises a first polymer layer, which may for example be made from parylene, deposited on the microbattery. The object of this first layer is on the one hand to limit the defects linked to the roughness of the substrate, and on the other hand to enable deformations of the component to be accommodated when the latter is used. The device compulsorily comprises a second layer forming a protective barrier. This protective barrier is formed for example by a layer of ceramic material or metallic material. It can be composed of a superposition of ceramic or metal layers for enhanced efficiency. Due to its small thickness (a few microns) and to the nature of the polymer materials, this device presents a greater flexibility than glass covers. However, its flexional range remains limited. Indeed, for too great flexional stresses, microcracks appear in the thin-film packaging device resulting in reduced protection.

FIGS. 2 and 3 respectively represent a one-dimensional structure 4 at rest and in flexion. FIG. 4 schematically represents the stresses in such a structure in flexion. Deformation of the structure 4 caused by flexion imposes a reduction of the top surface and an increase of the bottom surface, or vice-versa depending on the direction of the flexion force. The structure is therefore subjected to compressive stresses in a first part (the top part in FIG. 4) and tension stresses in a second part (the bottom part in FIG. 4). In the middle of structure 4, the compressive and tension stresses compensate one another creating a neutral plane, i.e. an area (illustrated by the dotted and dashed line) where the stresses are zero.

In conventional manner, the microbatteries are deposited on a substrate acting as mechanical support. The substrate generally has a thickness comprised between 100 μm and a few millimeters whereas the microbattery generally has a thickness comprised between 5 and 10 μm. As illustrated in FIGS. 5 and 6, a microbattery 2 situated on a surface of structure 4, for example a substrate, is therefore in a very high stress area. Microcracks are therefore liable to appear in the packaging device (not shown in FIGS. 5 and 6).

### OBJECT OF THE INVENTION

The object of the invention is to provide a microbattery packaging device remedying the shortcomings of the prior art. More particularly, the object of the invention is to provide a device that is flexible and easy to fabricate while at the same time preventing the occurrence of microcracks responsible for reducing the protection when a flexional stress is involved.

According to the invention, this object is achieved by the fact that the micro-battery packaging device arranged on a surface of a flexible support having a Young's modulus E_{sub} and a thickness t_{sub}, comprises at least one thin layer forming a protective barrier and covering the microbattery fully and said surface of the flexible support at the periphery of the microbattery, and by the fact that the device comprises a flexible compensation cover arranged on the protective barrier and made from a material having a Young's modulus E_{comp} and a thickness t_{comp} chosen to satisfy the following equation, with an accuracy of ±30%:

$${t}_{comp} = \frac{{t}_{sub}}{\sqrt{η}} , in which η = \frac{{E}_{comp}}{{E}_{sub}} .$$

A further object of the invention is to provide a method for producing such a device.

The method comprises forming the microbattery on the support, forming the protective barrier and forming the flexible cover having a Young's modulus E_{comp} and a thickness t_{comp} chosen to satisfy the following equation, with an accuracy of ±30%:

$${t}_{comp} = \frac{{t}_{sub}}{\sqrt{η}} , in which η = \frac{{E}_{comp}}{{E}_{sub}} .$$

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 represents a microbattery packaging device according to the prior art.

FIGS. 2 and 3 schematically represent a structure respectively at rest and subjected to a flexional stress.

FIG. 4 schematically represents the mechanical stresses in the structure according to FIG. 3.

FIG. 5 represents a structure in flexion comprising a microbattery according to the prior art.

FIG. 6 schematically represents the stresses in the structure according to FIG. 5.

FIG. 7 represents a structure in flexion comprising a microbattery according to the invention.

FIG. 8 schematically represents the stresses in the structure according to FIG. 7.

FIG. 9 represents a microbattery packaging device according to the invention.

FIGS. 10 and 11 respectively represent a composite structure and an equivalent non-composite structure.

FIG. 12 represents the position of the neutral plane of the structure according to FIG. 10 according to the thickness of the cover.

FIG. 13 represents a particular embodiment of the device according to the invention.

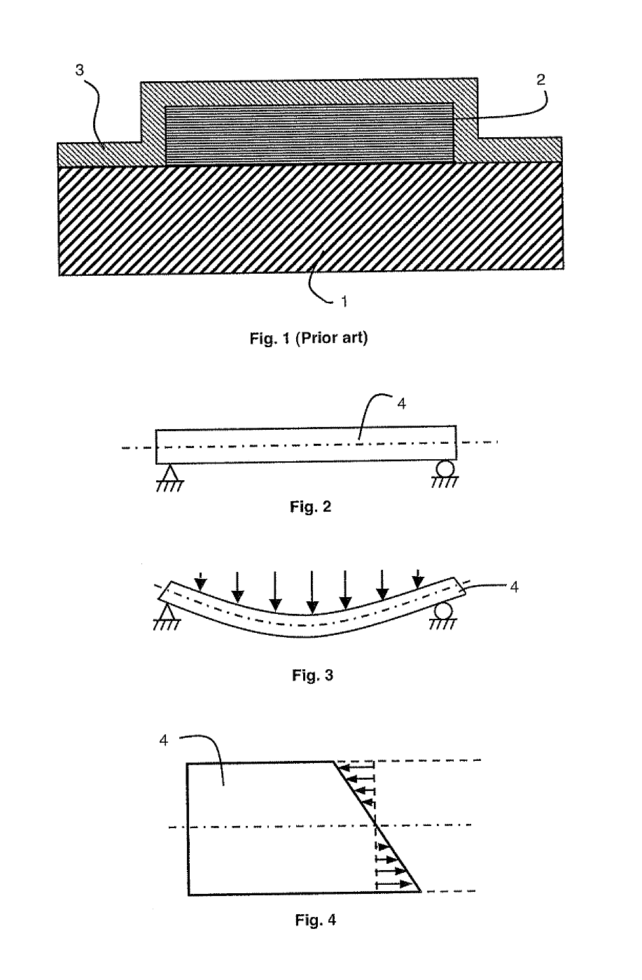

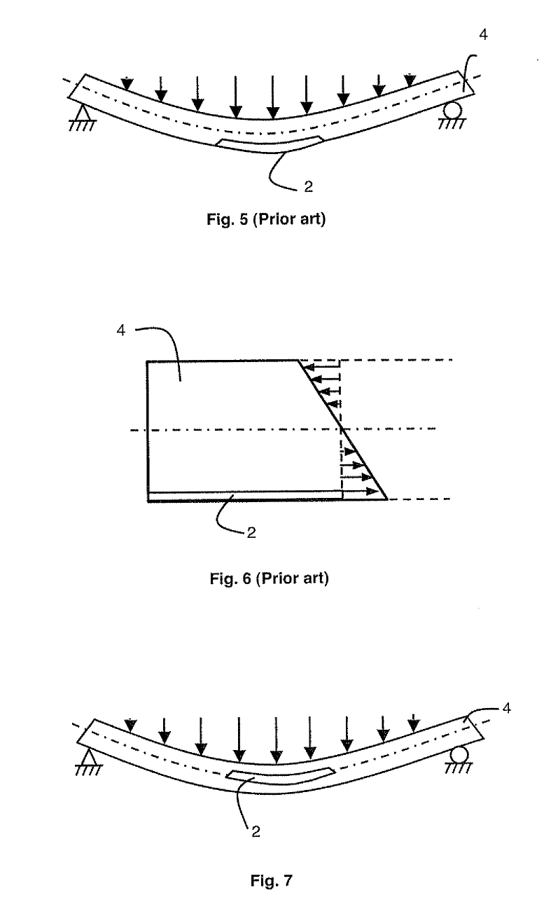

### DESCRIPTION OF PARTICULAR EMBODIMENTS

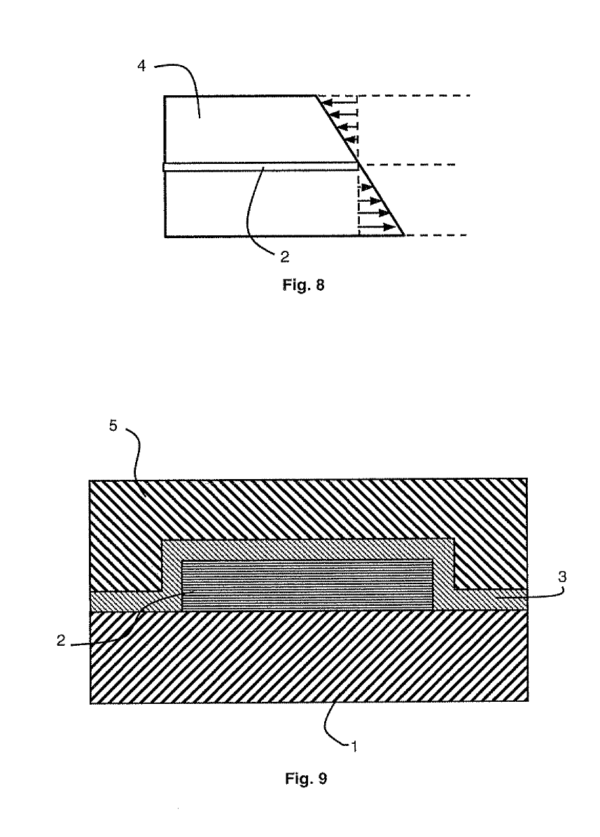

In the preferred embodiment of FIG. 7, battery 2, covered by its protective barrier (not shown) is placed as close as possible to the neutral plane (represented by the dotted and dashed line) of structure 4. In this area, called neutral plane or neutral axis, the mechanical stresses when flexion occurs are minimal (FIG. 8) and the barrier preserves its integrity. Such a configuration is represented in FIG. 9. The packaging device of microbattery 2, arranged on a surface of flexible support 1, comprises at least one thin layer forming protective barrier 3 and a flexible compensation cover 5. Barrier 3 covered by cover 5 is arranged on microbattery 2 and on support 1 at the periphery of the microbattery.

Compensation cover 5 is made from a material having a thickness and a Young's modulus that are chosen to have equivalent mechanical properties to that of support 1. The thickness and Young's modulus of the cover are chosen such as to situate the microbattery, arranged on the flexible support, as close as possible to the neutral plane of this composite support/microbattery/cover structure. Cover 5 does not on its own constitute a protective layer against diffusion of species and is therefore always associated with at least one thin layer forming a protective barrier 3, placed as close as possible to the microbattery. The protective barrier is generally formed by a dielectric or metal layer, or by a polymer/metal or polymer/dielectric multilayer system.

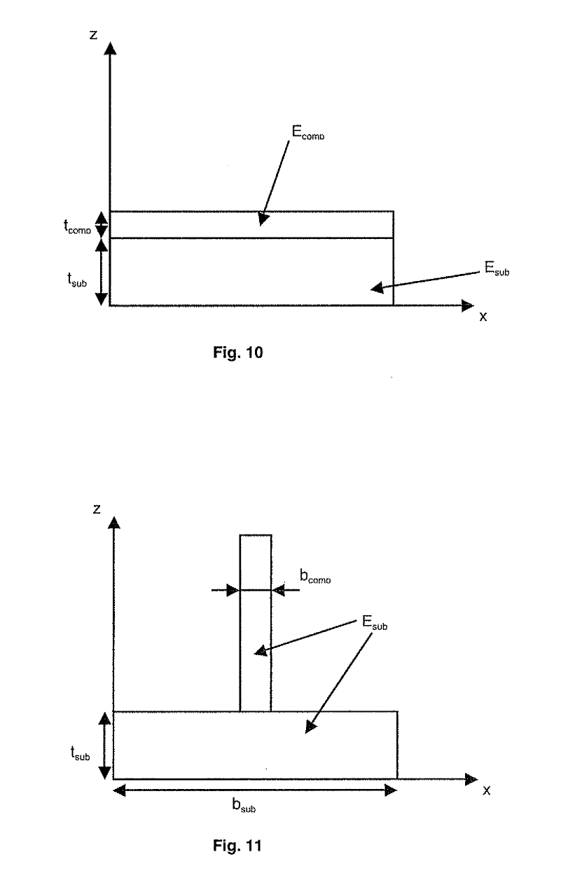

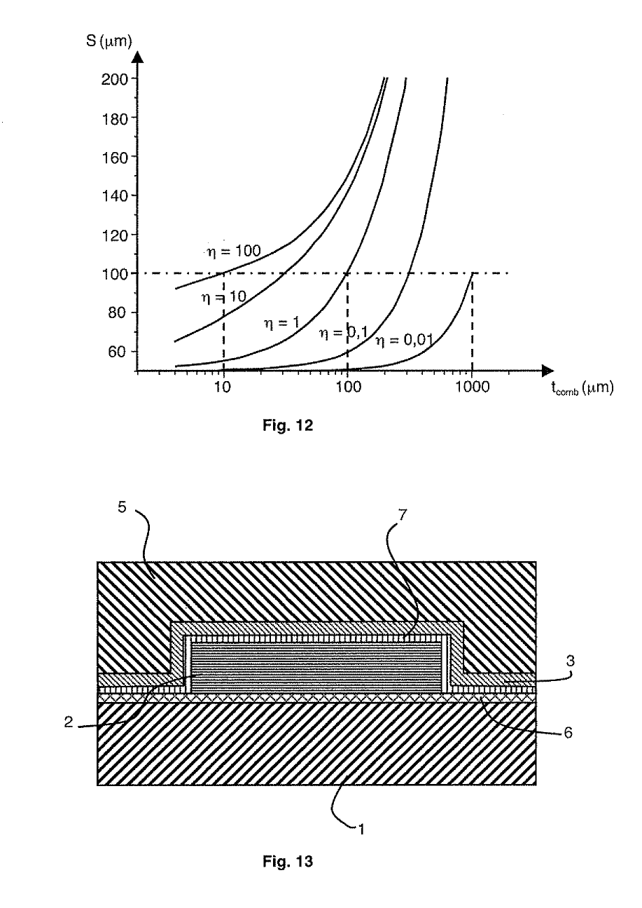

FIG. 10 represents a composite structure, i.e. composed of a layer of a first material and a layer of a second material, different from the first material. The top layer corresponds for example to compensation cover 5 having a thickness t_{comb} and a Young's modulus E_{comp}. The bottom layer corresponds for example to the flexible support having a thickness t_{sub} and a Young's modulus E_{sub}, different from E_{comp}. Taking one of the layers as reference material, the other layers can be assimilated to layers of the same material as the reference layer, but having a width that is proportional to the ratio of the Young's moduli. For example, in FIG. 11, the flexible support is chosen as reference material (E_{sub} and t_{sub}). The equivalent width b_{comp} of the compensation cover in the same material (E_{sub}) is given by the equation:

$${b}_{comp} = {b}_{sub} \cdot \frac{{E}_{comp}}{{E}_{sub}} = b \cdot η \qquad Eq . 1$$

in which

$$η = \frac{{E}_{comp}}{{E}_{sub}}$$

represents the ratio of the Young's moduli of the two layers. FIG. 11 therefore represents a non-composite structure equivalent to the structure represented in FIG. 10. From this equivalent non-composite structure, calculation of the position of the neutral plane, or neutral axis, can be performed. The position of the neutral plane along the z-axis is given by the following equation for a number of layers n:

$$S = \frac{{\sum }_{i = 1}^{n} {z}_{i} {A}_{i}}{{\sum }_{i = 1}^{n} {A}_{i}} \qquad Eq . 2$$

zᵢ being the coordinate on the z-axis of the neutral axis of each layer, i.e. the middle of each layer, and Aᵢ being the surface of the cross-section of each layer in the plane xz. For example purposes, in FIG. 11, in the bottom layer zᵢ=t_{sub}/2. With the structure of FIG. 11, the equation Eq. 2 can be developed as follows:

$$S = \frac{( \frac{{t}_{sub}}{2} ) \cdot {t}_{sub} \cdot {b}_{sub} + ( {t}_{sub} + \frac{{t}_{comp}}{2} ) \cdot {t}_{comp} \cdot {b}_{comp}}{{t}_{sub} \cdot {b}_{sub} + {t}_{comp} \cdot {b}_{comp}} \qquad Eq . 3$$

The equivalent width b_{comp} of the compensation cover expressed as a function of the width of the support b_{sub} and of the ratio of the Young's moduli η by equation Eq. 1 enables this equation to be simplified:

$$S = \frac{1}{2} \cdot \frac{{{t}_{sub}}^{2} + 2 η {t}_{comp} \cdot {t}_{sub} + η {{t}_{comp}}^{2}}{{t}_{sub} + η {t}_{comp}} \qquad Eq . 4$$

The latter equation makes it possible to calculate the position on the z-axis of the neutral plane in a flexible support/cover structure composed of materials with different Young's moduli.

FIG. 12 represents the position S versus the thickness of compensation cover t_{comp} for a support thickness t_{sub} of 100 μm and different values of η. The different plots of FIG. 12 show that the neutral plane of the structure is not necessarily situated at the interface of the support and compensation cover, i.e. at 100 μm. The thickness of the cover t_{comp} and the Young's modulus of the cover E_{comp}, linked to the material of the latter, therefore have to be chosen so as to situate the neutral plane at the interface between the support and the cover. In this case, S is equal to the thickness of the support t_{sub} and equation Eq. 4 can be simplified:

$${t}_{comp} = \frac{{t}_{sub}}{\sqrt{η}} \qquad Eq . 5$$

Equation Eq. 5 therefore enables the thickness of the cover t_{comp} to be calculated according to the Young's moduli and the thickness of the support t_{sub} so that the neutral plane of this structure is situated near the top surface of the support. In this case, this structure is said to be balanced. In the case of a structure with three layers, support/microbattery/cover for example, if the support/cover pair is balanced, the neutral plane is then situated in the intermediate layer, the microbattery in this example. As it is situated in proximity to the neutral plane, the microbattery is subjected to little stress on flexion.

For example in FIG. 12, for η=0.01 and a substrate thickness of 100 μm, a neutral plane situated at 100 μm gives a thickness t_{comb} of the cover of 1000 μm. As the cover material has a Young's modulus one hundred times lower than that of the support, its thickness is ten times larger than that of the support. In another example, for η=100, the thickness of the cover t_{comp} is 10 μm to obtain, in like manner, a neutral plane situated at 100 μm.

The thickness of the compensation cover is calculated from equation Eq. 5 with an accuracy of ±30%. In a preferred embodiment, the accuracy is ±10%. The thickness of the cover is furthermore preferably at least five times larger than that of the microbattery and the protective barrier, thereby enabling the stress level in the microbattery to be reduced.

As the packaging device described above has to be flexible, the material of the cover is preferably chosen from the polymer family. The cover material can be chosen from the following non-exhaustive list, also giving the associated Young's modulus (in MPa):

| Polymethyl methacrylate (PMMA) | 2300 to 3200 |
|---|---|
| Polyamide | 3000 to 5000 |
| Polycarbonate (PC) | 2300 |
| Polyethylene (PE) | 200 to 700 |
| Polystyrene (PS) | 3000 to 3400 |
| Polyvinyl chloride (PVC) | 3000 |
| Polyethylene naphtalate (PEN) | 500 to 1500 |
| Polytetrafluoroethylene (PTFE) | 750 |
| Polyvinylidene fluoride (PVDF) | 350 to 1100 |
| Polypropylene (PP) | 1500 |
| Polyxylylene (PPX) | 2400 to 3200 |
| Silicon | 5 to 500 |
| Polyimide | 3200 |
| Epoxy resin | 3500 |

In practice, the cover has to be intimately bound to the microbattery in all places for equation Eq. 5 to be valid. Deposition techniques of the cover on the microbattery and protective barrier are particularly well suited. Chemical Vapor Deposition (CVD), spin coating and ink-jet deposition can be used. Other bonding or hot lamination techniques are possible. Bonding techniques using a peripheral adhesive thread are on the other hand unsuitable.

In the particular embodiment of FIG. 13, the compensation cover and the support are formed in the same material, for example kapton. Microbattery 2 is deposited on a kapton substrate with a thickness of 150 μm acting as mechanical support 1 and covered by a tungsten layer 6 with a thickness of about 200 nm. Protective barrier 3 is formed by successive stacking of five thin layers, for example alternately silicon oxide (SiO₂) with a thickness of about 100 nm and silicon nitride (Si₃N₄) with a thickness of about 50 nm. This protective barrier 3 is deposited on kapton cover 5 with a thickness of 150 μm. Cover 5, covered by the protective barrier, is then fixed onto the microbattery and support by sticking. The adhesive is for example an epoxy resin represented by layer 7 in FIG. 13. Cross-linking of the adhesive enabling cover 5 to be secured to microbattery 2 and to support 1 is preferably performed by exposure to ultraviolet rays.

In an alternative embodiment, the microbattery is deposited on a support made from polymethyl methacrylate (PMMA) with a thickness of 50 μm covered by a layer of about 100 nm of silicon nitride. The protective barrier, deposited directly on the microbattery and its substrate, is composed by stacking a layer of parylene with a thickness of 2 μm, produced by vacuum evaporation, and a layer of titanium with a thickness of about 200 nm produced by vacuum magnetron sputtering. Finally, the compensation cover is produced by spin coating of 35 μm of an epoxy resin, cross-linked by 50 min exposure to ultraviolet rays.

1. Packaging device of a microbattery arranged on a surface of a flexible support having a Young's modulus E_{comp} and a thickness t_{comp}, the device comprising at least one thin layer forming a protective barrier and covering the microbattery fully and said surface of the flexible support at the periphery of the microbattery, device comprising a flexible compensation cover arranged on the protective barrier and made from a material having a Young's modulus E_{comp} and a thickness t_{comp} chosen to satisfy, with an accuracy of ±30%, the equation
$${t}_{comp} = \frac{{t}_{sub}}{\sqrt{η}} , in which η = \frac{{E}_{comp}}{{E}_{sub}} .$$

2. Device according to claim 1, wherein the accuracy is ±10%.

3. Device according to claim 1, wherein the support and the cover are formed from the same material.

4. Device according to claim 1, wherein the material forming the cover is a polymer.

5. Device according to claim 1, wherein the cover is at least five times thicker than the microbattery.

6. Method for producing a device according to claim 1, comprising forming the microbattery (2) on the support (1), forming the protective barrier (3) and forming the flexible cover (5), the flexible cover having a Young's modulus E_{comp} and a thickness t_{comp} chosen to satisfy, with an accuracy of ±30%, the equation
$${t}_{comp} = \frac{{t}_{sub}}{\sqrt{η}} , in which η = \frac{{E}_{comp}}{{E}_{sub}} .$$

7. Method according to claim 6, comprising successively forming the protective barrier by deposition of thin layers on the cover and fixing by an adhesive the cover covered by the barrier onto the support equipped with the microbattery.

8. Method according to claim 7, wherein the adhesive is an epoxy resin.

9. Method according to claim 6, comprising forming the cover by deposition on the protective barrier previously deposited on the microbattery and the support.

10. Method according to claim 9, wherein the step of forming the cover is achieved by spin coating.

11. Method according to claims 6, wherein the material forming the cover is an epoxy resin.
